(19) United States
(12) Patent Application Publication
(10) Pub. No.: US 2006/0184443 A1
(43) Pub. Date: Aug. 17, 2006

(54) Method for conducting an on-line forum for auctioning intangible assets

(76) Inventors: Amir Erez, Bell Canyon, CA (US); Jonathan A. Gonen, Calabasas, CA (US); Shlomo Gonen, Calabasas, CA (US); Yuri Mordovskoi, Santa Monica, CA (US); Danny Rosen, Valley Village, CA (US)

Correspondence Address: KELLY LOWRY & KELLEY, LLP, 6320 CANOGA AVENUE, SUITE 1650, WOODLAND HILLS, CA, 91367, US

(21) Appl. No.: 11/060,634

(22) Filed: Feb. 16, 2005

(51) Int. Cl. G06Q 40/00

(52) U.S. Cl. 705/37

(57) ABSTRACT

An on-line forum for auctioning non-performing assets includes offering for auction sale of non-performing assets in a lot of as few as a single asset or a plurality of assets following completion of a third-level registration. Access to a limited amount of information on the on-line forum is permitted without registration. Additional information is accessed following completion of a first level registration. Direct communication is facilitated between one or more registered potential bidders and a registered seller in an on-line discussion forum. Assets offered in the on-line forum auction are bidded upon following completion of second level registration by each potential bidder. Collection assistance may be provided to the on-line forum bidders.

### BACKGROUND OF THE INVENTION

The present invention is generally related to on-line auctions. More particularly, the present invention relates to a method and system for auctioning intangible assets, and particularly non-performing assets.

Typically, commercial transactions between businesses and individuals involve the seller of a good or service, typically referred to as a merchant delivering the good or service to the purchaser or buyer in advance of receiving payment or at least full payment. From the time that the goods/services are delivered until such time as the buyer pays for it, the merchant is said to have an account receivable with the buyer. This account receivable is a financial asset that indicates the expectation of future payment according to the terms of the commercial relationship between the merchant and buyer. In certain industries, a merchant generates account receivables by extending credit on virtually all of its sales. Therefore, the timely and complete payment of the account receivables is critical to the cash flow of any merchant.

Commercial account receivables is one of the largest classes of financial assets in developed economies. In the United States, it is estimated that the outstanding amount of commercial account receivables has a total annual volume of approximately $60 trillion. Despite this immense size, commercial account receivables are generally illiquid. There are presently only a limited number of ways to fund account receivables, including using the merchant's internal capital, borrowing from a bank or other financial institution by pledging the accounts receivables as collateral, factoring, assignment to collection, issuing commercial paper, or securitizing the merchant's accounts receivables.

However, these ways to fund account receivables are not ideal. For example, if timely and complete payment of account receivables is not met, the merchant will be left without the necessary cash to meet its own financial obligations, making it difficult to fund the account receivables using the merchant's own internal capital. Furthermore, using the merchant's internal capital is inefficient since it uses the merchant's long-term capital to meet a short-term lower risk funding requirement. Borrowing from a bank or other financial institution against the account receivables entails the merchant's endurance of restricted covenant upon its business and financial management practices, as well as the payment of high interest rates as these types of loans are perceived to be somewhat risky. Factoring, an arrangement between a financing company and a merchant whereby the factor purchases the merchant's account receivables is also not ideal. The factoring company purchases the account receivables at a discount as it is known that at least some of the buyers will default on their debts, collection can be difficult and costly and requires bookkeeping and legal resources. Assigning the account receivables, typically non-performing or delinquent account receivables, to a collection agency also presents drawbacks. The collection agency is typically only willing to pay pennies on the dollar for such assets, or agrees to pay a certain percentage (typically less than 50%) of the collected debt. Usually, only large corporations are eligible for short-term fixed income instruments, collectively known as commercial paper, or otherwise securing credit against the account receivables.

In sum, cost effective account receivables funding is usually available only for larger organizations, but not smaller and medium sized businesses. Moreover, account receivables funding is costly.

The task of collecting even on a performing account receivable assets can be daunting due to the record keeping, administration and collection requirements which generally consume an inordinate level of management and staff resources, particularly for medium and small-sized commercial enterprises. Most businesses are simply ill-equipped or otherwise unwilling to put forth the time, effort and resources in pursuing non-performing assets. Thus, the selling of bad debt or non-performing assets has, in many respects, become the preferred method for disposing of it. Selling the bad debt to a third party ensures some payment to the creditor, unlike collection efforts which may be unsuccessful, and the risk of collection passes to the third-party buyer of that debt.

Performing assets can be generally categorized as those in which a steady stream of income is being generated, the debtor is not delinquent or at least is continuing payment, or the asset does not have a delinquent balance. For example, performing assets can include commercial account receivables, bankruptcy positions, notes such as promissory notes or mortgages, intellectual property including trademarks and patents, etc. Non-performing assets are typically considered those assets in which there is delinquency or refusal to pay debt. These assets can include unpaid invoices (secured or unsecured), consumer debt in the form of auto loan deficiencies, credit cards, consumer loans, dishonored checks or NSF checks, medical/healthcare payments, student loans, etc. These non-performing assets may result in a legal judgment so as to enforce their payment or collection of other assets or garnishment of wages to pay the debt.

As discussed above, such intangible assets are sold in large lots representing hundreds or thousands of individual bad debts from one large organization to large collection agencies or financiers. Selling such assets in large lots reduces the overall value of each individual asset as the purchaser must consider that many of the debts will never be collected upon. Another disadvantage of this existing process is that smaller and medium sized businesses are effectively left with little choice but to send their non-performing assets to collection agencies which only charge a percentage of the revenues generated as a result of collection, or pay pennies on the dollar of the face value of the debt.

On-line auctions have been regularly used to sell products to the bidder who posts the highest bid. In recent years, this method of selling has gained much popularity among growing businesses and product merchants. The reasons for this relate to the selling advantages that can be offered by on-line auctions. For example, on-line auctions allow the seller to obtain a far greater customer reach that is not offered by other selling methods. In this respect, many more consumers can participate in the sale of a good since they can join the auction at any place and time by simply logging onto the appropriate Internet web-site. Although on-line auctions have become increasingly popular, no system is in use which is adapted to focus on auctioning intangible assets, and particularly non-performing assets or bad debt to enable small and medium businesses to auction off intangible assets and their bad debt. Such an on-line auction system would also enable larger organizations to break up their “lots” and potentially increase the value of each asset. Such an on-line auction system could also present many advantages to potential buyers who could purchase an asset, such as a non-performing asset, at a discounted rate for a relatively quick and high return on investment. The present invention fulfills these needs and provides other related advantages.

Accordingly, there is a continuing need for a method for conducting an on-line forum for auctioning intangible assets so as to overcome the aforementioned disadvantages. The present invention fulfills this need and provides other related advantages.

### SUMMARY OF THE INVENTION

The present invention resides in a method for conducting an on-line forum for auctioning intangible assets, and particularly non-performing assets, on a communications network, such as the Internet. The present invention provides a method and system for facilitating the buying and selling of non-performing assets. The present invention facilitates many buyers to merchants trading relationship, whereas previous bad debt from funding methodologies employed a one-to-one relationship. The present invention also enables small and medium-sized businesses, government entities or even individuals to collect on non-performing assets by selling such assets to others who are in a position or willing to expend the time and resources to collect on the asset. The present invention also empowers the general public to purchase non-performing assets at a discounted price, become educated as to the process for collecting on such debts, and be presented with the opportunity of a relatively quick and high return on their investment.

The present invention generally comprises the steps of permitting access to a limited amount of information including viewing auctions and on-line discussions in the on-line forum without registration. Additional information is accessed, such as participation in on-line discussions, in the on-line forum following completion of a first level registration. Bidding on assets offered in the on-line forum is allowed following completion of a second level registration. Individuals, small businesses or even large organizations can offer for auction sale unlisted/unregistered assets in the on-line forum following completion of third-level registration, which typically requires obtaining third-party credit verification of the seller.

A registered seller conveys information concerning the assets to be auctioned to the on-line forum. This conveyance may comprise using the communications network to convey a file containing the asset information, or contacting representatives of the on-line forum by telephone for manual input of the asset information by the representatives. The assets may comprise a single asset or a plurality of assets offered as a lot. Typically, the assets comprise non-performing assets.

The present invention enables the creation of a graphical representation of the asset for viewing at the on-line auction forum. Such graphical representation can be an NSF check, a court document or an invoice, as well as viewing of due diligence documents and background information regarding the asset.

The invention facilitates direct communication between a registered potential bidder and a registered seller of the assets being auctioned in the on-line forum. Such communication is provided in an on-line discussion forum for users having a first level registration or higher. The invention may also provide and facilitate private communication between a seller and a selected buyer or group of buyers. The invention permits a seller to choose an auction open to all bidders, or restricted to a selected group of one or more bidders or a class of bidders, such as by seller invitation.

A bidder may subscribe to an auction alert, wherein the bidder is informed by the on-line forum when a higher bid then the bidder's has been made for an asset. This information may be conveyed using e-mail, instant messaging or telephonic communication.

The present invention preferably provides collection assistance to on-line forum bidders. The assistance may include educational tutorials, forms and e-filing in the on-line forum and/or providing links to third-party sources of collection information. Such third-party links can include links to collection professionals, links to public records potentially containing debtor location or asset information, or the like.

Preferably, a seller is rated after an auction. Buyers may also be rated for future buyer and seller use in future auctions, etc. Third party services may also be rated and viewed by buyers as well, so as to rate previous buyer experience with the service provides such as escrow, notary, database provider, skip tracers and collection agencies.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a flow chart depicting the general steps taken in the overall method of the invention;

FIG. 2 is a flow chart depicting the steps taken in accordance with the present invention;

FIG. 3 is a flow chart depicting the steps in a bidding process of the present invention;

FIG. 4 is a flow chart depicting in more detail the steps taken in the bidding process of the present invention;

FIG. 5 is a flow chart depicting the steps taken in accordance with a posting process of the present invention; and

FIG. 6 is a flow chart depicting the steps taken during the posting process of the present invention.

### DETAILED DESCRIPTION OF THE PREFERRED EMBODIMENTS

As shown in the accompanying drawings, for purposes of illustration, the present invention resides in a method for conducting an on-line forum for auctioning intangible assets, and in particular non-performing assets such as, but not limited to, delinquent commercial or consumer debt, credit cards, loans, unpaid invoices, insufficient checks (NSF), defaulted student loans, secured and unsecured debt, tax liens and other government debt. As will be more fully described herein, the present invention enables an entity of any size from an individual to a large organization to post and sell/auction such intangible assets individually or in various lot sizes. The present invention also enables not only sophisticated traditional collection agencies and buyers of such assets, but also the public at large to sell and buy the assets. It is believed that opening the market to the public at large will increase the value of the intangible assets offered during the auction and increase the collection rate of the non-performing assets.

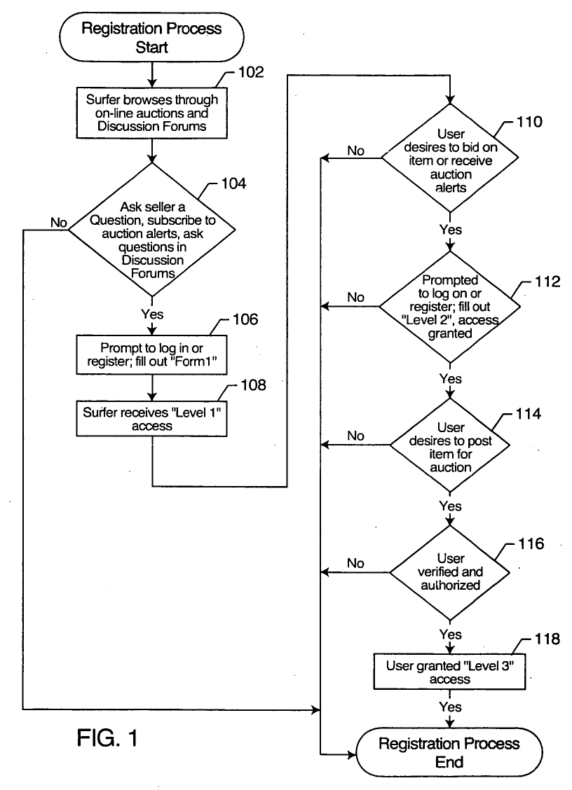

With reference now to FIG. 1, the overall methodology of the system is illustrated. An on-line forum, typically in the form of a web-site, is established and designed for auctioning of intangible assets, including non-performing assets and the like. A surfer or non-user may access the on-line forum and browse through public auctions and discussion forums between buyers and sellers (102) without the need for registration. If the surfer wants to ask a seller a question, subscribe to auction alerts, or the like (104) he is prompted to log in and register by filling out “form 1” (106). If he does not wish to register or participate other than viewing, there is no registration but the non-user surfer is still permitted to view certain limited amounts of information on the web-site.

However, if the surfer registers by filling out Form 1, he receives a “user L1” or first level access (108). This gives additional access to the now registered user, including participation in the on-line discussions.

If the user desires to bid on an item, or receive auction alerts (110), the user is prompted to log in or register and fill out “form 2” or otherwise gain second level access (112).

If the user (surfer, registered level 1 or level 2 user), desires to post an item such as a non-performing asset or group of assets for auction (114), the user must be verified and authorized (116). The buyer or seller can be authorized in different ways such as identification verification, credit verification, use of a telephone registration verification system, which will be more fully described herein, etc. If the user is verified and authorized, the user is granted a level 3 access (118) and is able to post items for auction on the on-line forum. This ends the registration process.

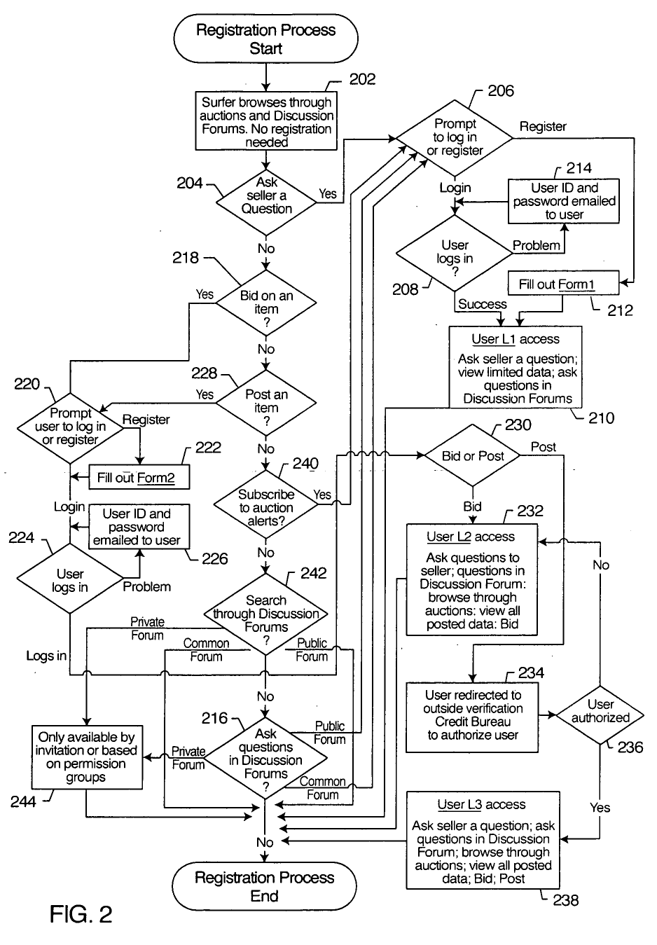

With reference now to FIG. 2, the registration process generally described above is illustrated and will be described more fully in detail. As discussed above, any on-line user including professionals, non-professionals of the general public, etc., can access and browse the on-line forum and be provided a limited amount of information including browsing the status of public auctions and discussion forums between buyers and sellers without registration (202). This enables the non-registered user to become informed of the web-site, learn how the overall auction process works in accordance with the present invention, and otherwise become curious and interested in becoming a registered user.

In a particularly preferred embodiment, the on-line forum has established an on-line discussion forum which enables buyers and sellers to communicate with each other. This enables potential buyers to seek answers to questions concerning the items which are being auctioned. The on-line discussion forum also enables buyers and sellers to communicate with each other so as to answer other questions that may not be related to any particular items for auction, but rather as a common forum to educate one another as to the collection process, give information about themselves or other buyers and sellers. Such on-line discussion forum is typically in the form of instant messaging or e-mailing correspondence or the like, although other communication methods are possible as well. When the discussion forum is a public discussion, registered and non-registered users are able to view the discussion.

However, if a non-registered user wants to participate in the discussion forum and ask a seller a question (204), the user is prompted to log in and register (206). If the user is already registered, that user must log in (208) and have his level 1 access confirmed in order to ask the seller a question, view limited data, and the like (210). However, if the user is not registered, the user must fill out form 1 or registration level 1 (212). The user is granted an identification (214) and password which may be assigned or selected by the user. When attempting to log in if there is a problem with logging in, such as forgetting the identification, password, etc., the user I.D. and password can be conveyed to the user, such as by e-mail or the like once the user is confirmed as a registered user. This enables the registered user having at least level access 1 to ask questions in discussion forums and the like (216), so long as the forum is a common or public forum.

The on-line forum in the form of the web-site is typically controlled by a system or forum administrator. In order to make the system commercially viable, the administrator may require a fee in order to gain first level access and register. The on-line forum may also include third-party links which can be in the form of advertisements, banners, or radio buttons which generate income to the system administrator by their presence on the web-site, when “clicked” or the like.

In a particularly preferred embodiment, the on-line forum includes resources to assist the buyers and sellers in accomplishing their goals. For example, the on-line forum may include pull-down menus, tutorials, etc., which provides information on the overall bidding and auctioning process, information on the various intangible assets which may be auctioned, “how to” steps and tutorials for collecting on non-performing assets, obtaining judgments, etc. These resources may be in the form of non-affiliated third-party links to other web-sites and collection professionals, etc. The third-party links may also include links to governmental and public establishments, such as public records which could potentially contain debtor location or asset information, judgment information, etc. In this manner, non-professionals can learn what the various intangible assets are, learn how the bidding and auctioning process works, and how to obtain a judgment or enforce a judgment so as to collect on the non-performing assets which he has bought.

It will be appreciated by those skilled in the art that the public access and education/resources provided at the on-line forum opens the collection process form a few large organizations to the public at large whether they be professional or non-professional. This enables an individual working from his or her home to become versed in the collection business, bid on and buy assets for sale, and obtain and enforce judgments so as to collect from a non-performing asset and hopefully generate a greater revenue on the asset than what was paid for the asset during the auctioning process.

Users of the on-line forum of the present invention are able to select and sort from the various items for auction by dollar amount, geographic location (zip code, city, state), type of instrument (note, NSF checks, delinquent credit card balances, judgments, etc.) or the like. Thus, the invention could potentially enable an individual who is a non-professional to become educated as to the collection process, bid on and buy various non-performing assets pertaining to individual's residing in the bidder's neighborhood and due to the buyer's familiarity with the neighborhood or city could more successfully obtain and enforce the judgments and collect on the non-performing assets. It is anticipated that this will bring a greater auction price to the seller and potentially also result in an increased revenue and collection rate.

Referring again to FIG. 2, if a surfer or first level user desires to bid on an item (218), the user is prompted to register (220) such as by filling out form 2 (222) and/or use their log-in I.D. and password to log in and be granted access to that portion of the system (224). Again, if the user identification and/or password are forgotten or if there are other problems with logging in, the user I.D. and password are conveyed to the user (226) such as by e-mail so that the user can log-in and obtain access. The registration form includes requests for bidder information, including name, address, telephone number, e-mail address, whether the buyer is a professional or non-professional, etc.

If the user (registered or unregistered) desires to post an item for sale and auction (228), the user is directed to log in and verify their second level access or register to gain second level access as described above in steps (220-226). When second level access is obtained, and the user is logged-in, the system will inquire whether the user desires to bid or post (230). If the user desires to bid, the level 2 access user is allowed to ask questions to the seller in the discussion forum, through auctions, view all posted public data and bid on auctions (232).

However, if the user desires to post an item, the user must be verified and authorized. This typically entails the user being redirected to an outside verification credit bureau, such as Equifax, Transunion, or the like, to authorize the user (234). The outside verification entity will authorize the user using “in wallet” or “out of wallet” questions for identification, credit verification, etc. Preferably, a limited number of attempts is granted to the user to become authorized, such as two attempts per IP address, so as to prevent fraud. As part of the verification process, the identity of the seller may be verified and confirmed. This may be done by any form of screening, but can include the seller being positively identified by at least a telephone number and e-mail address wherein the seller is contacted by telephone and given a registration or verification code either via the telephone, Internet or other means for entering on the web-site, spoken into the telephone, entered by keypad into the telephone, etc., as disclosed in currently pending U.S. patent application Ser. No. 11/034,421. If the user becomes authorized (236), the user is granted level 3 access, which enables the user to have access to both level 1 and level 2 information including asking seller and buyers questioning the on-line discussion forum, browsing through auctions, viewing all posted data, bidding as well as posting items for sale (238). However, if the user cannot be authorized, they are only granted level 2 access and are not able to post items for auction.

The present invention also enables users to subscribe to auction alerts (240) wherein a user must have at least a first level access and subscribes to an alert system for a particular auction wherein when the bid changes or exceeds a certain level the user is informed of the new price. The invention also enables users to search through the discussion forums, such as searching for particular buyers or sellers or auction items so as not to be burdened with viewing all of the discussions concerning all of the buyers, sellers and items being auctioned (242).

The on-line discussion forum can be a common or public forum wherein all users to the web-site have access, or can be set up as a private forum only available by invitation or based on permission groups (244). For example, a registered seller may wish to only communicate with a particular selected buyer or buyers, potential buyers in only a given geographic location, professional buyers versus non-professional buyers, buyers having a level 2 access, etc. In the discussion forums, the identity of the seller may also be kept secret at the seller's desire. For example, a bank may not wish to have its identity known and associated with the items it is auctioning. This pertains not only to the private forum discussion groups, but also the common or public discussion forums.

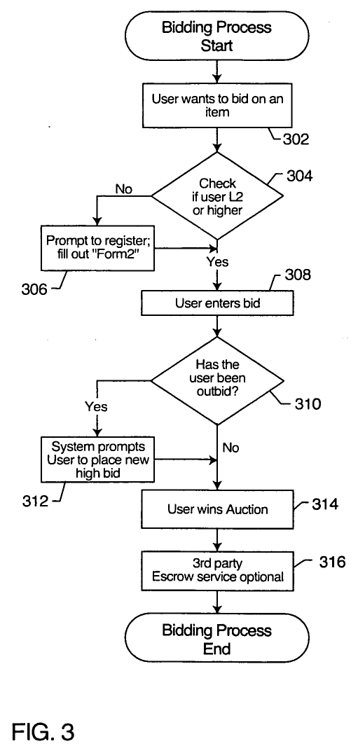

Referring now to FIG. 3, the steps of the general bidding process are illustrated for when a user wants to bid on an item (302). The system first checks to see if the user has a second level registration or higher (304). If not, the user is prompted to registered and fill out form 2 registration (306). However, if the user is registered, or just recently registered in step 306, the user logs in with his identification and password and is allowed to enter a bid (308) on an auction item.

Over time, the system determines whether the user has been outbid (310). That is, the system has an “autobid database” which is checked for the highest bid. The user will either have subscribed to the auction alert system described above, or the system may be designed such that the active and registered bidders are automatically contacted, such as by e-mail, instant messaging, telephone, fax, or the like, when the bidder has been outbid. In that case, the system prompts the user to place a new high bid (312). If the original bid or new high bid is the highest bid, the user wins the auction (314) and arranges for transfer of title of the asset(s), such as by using a third-party escrow service or the like (316).

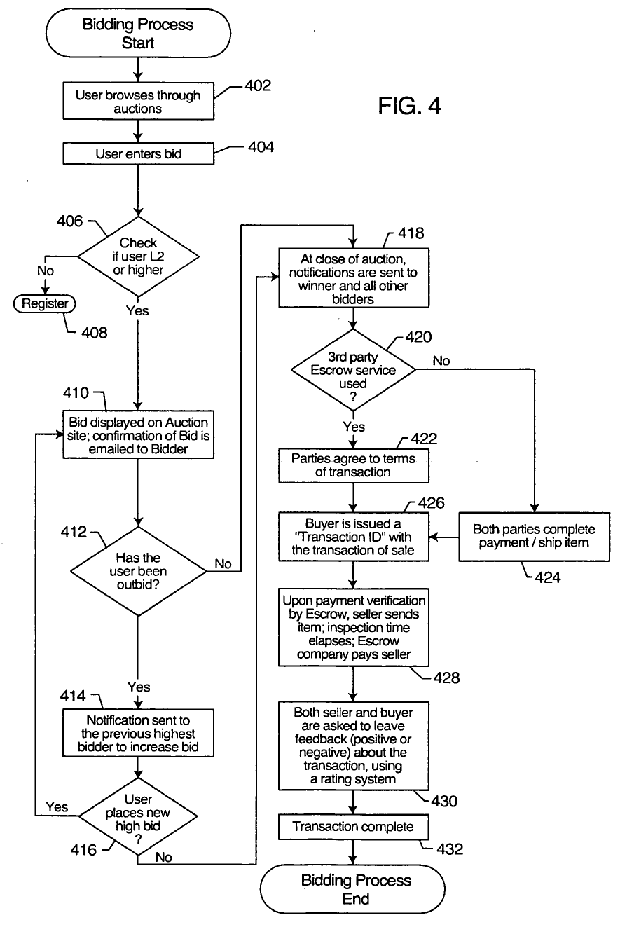

With reference now to FIG. 4, a more detailed illustration of the steps taken during the bidding process is shown. The user (unregistered surfer or previously registered user) browses through the available auctions (402). In a particularly preferred embodiment, the invention provides thumbnail images of the items to be auctioned. For example an item representing an NSF check can have a symbol of a check stamped with the symbol “NSF” or the like. Delinquent credit card accounts can have a picture of a generic credit card, judgments and liens can be in the form of an official representation of a judgment or lien, etc. As will be described more fully herein, when the information is provided by the seller to the on-line forum, this information can be automatically entered into such graphical representations such that when the thumbnail image is selected, such as by clicking on it with one's mouse, the image pops up of a representation of the actual document with the pertinent information pertaining to that particular asset. In other cases, the seller may pay in order to have the capability of importing this information into the graphical representation. The graphical representations are intended to provide a realistic look and feel of the asset to the bidder, and assist the bidder in visually distinguishing assets by their thumbnail graphical representations. Due diligence documents specific to the actual posting may also be uploaded and serve as the graphic illustration and auction thumbnail.

When finding an asset or a plurality of assets offered in a lot, the user can enter a bid (404). Before allowing the bid to be entered, the system will check to see if the user has a level 2 access or higher (406). If not, the user is prompted to register (408), as discussed above. If so, the user is prompted to log in and bid is displayed on the auction site and confirmation of the bid is conveyed to the bidder, such as by e-mail or the like (410).

Then, as described above, the system determines whether the user has been outbid (412). If so, the user is notified of the increase in the bid (414). The system may elect to only notify the previous highest bidder or all previous highest bidders in this particular auction. The user(s) is then invited to place a new high bid (416), and then the bid is displayed on the auction site and confirmation is sent to the bidder (410) to create a looping process until a user is not outbid and the auction closes. The close of the auction may be determined by establishing a given time to auction the items established by either the seller or the system administrator, exceeding a certain dollar amount and reaching a time limit, or the like. At the close of the auction, notifications are sent to the winning bidder and all other bidders (418).

The winning bidder and the seller can be invited to participate in a third-party escrow service (420). One or a series of third party escrow services can be provided to the buyer or seller, and the buyer or seller can decide to use such service at their own discretion. If the buyer and seller wish to use an escrow service, the parties agree to terms of the transaction (422). If they do not, the parties complete the payment and ship the item or otherwise transfer the title as agreed amongst themselves (424). In any event, preferably, the buyer is issued a transaction identification code or number evidencing the transaction of sale (426). The transaction identification is for tracking the item in case there are problems. Upon payment verification by either the third-party escrow service or the seller, the seller or escrow company sends the item to the buyer. Typically, the buyer is allowed an inspection time to verify that the item is as was represented by the seller. In such instance, when the inspection time elapses or the buyer grants its express approval, the escrow company pays the seller (428).

In a particularly preferred embodiment, the invention incorporates a rating system wherein buyers can rate sellers, sellers can rate buyers and provide positive or negative feedback about the transaction about the buyer and/or seller (430). This can give confidence to future bidders and buyers of a highly rated seller, or warn bidders and buyers of a poorly rated seller, or provide an impetus for the bidder to ask questions to the seller regarding the low ratings on previous transactions.

The transaction is completed (432) and the bidding process ends. An on-line Notary may be provided by the on-line forum or the on-line forum may facilitate a link to a notary to facilitate the process of the sale and post sale transactions.

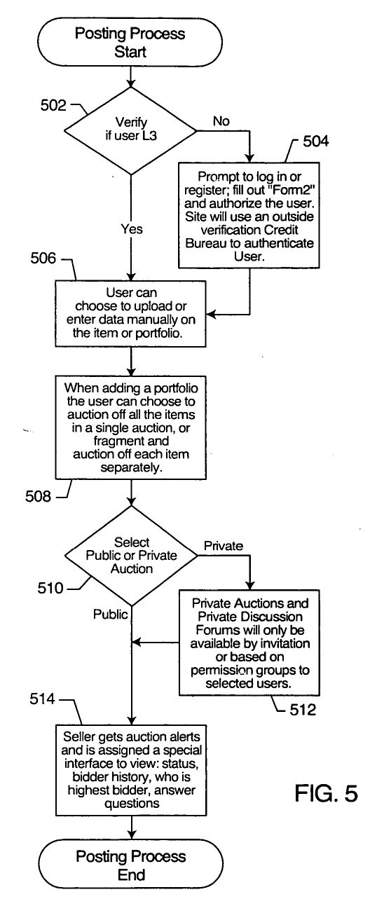

With reference now to FIG. 5, a flow chart is shown illustrating the general steps in the posting process for posting an item or a plurality of items as a lot for auction. First, the system verifies that the user has a third-level registration (502). If not, the user is prompted to either log in as a third-level user or register and fill out “form 2” and authorize the user using a verification credit bureau to authenticate the user, as discussed above (504). The user/seller can choose to upload information concerning the one or more intangible assets for auction or contact the on-line forum or third party representative thereof for manual entry via telephone or the like (506), as will be discussed more fully herein. When the seller has a portfolio comprised of a plurality of assets to be sold, such as a plurality of delinquent loans, account receivables, etc., the seller can choose to auction off all the items in a single auction as a single portfolio, or fragment and auction off each item or group of items separately (508).

The seller is also able to select whether to conduct a public or private auction (510). If a private auction is selected, the seller selects permission groups or invites potential buyers to participate in the private auction and private discussion forums (512). Whether the auction is private or public, the seller obtains auction alerts and is assigned a special interface to view the status of the auction, bidder history, who is the highest bidder, and answer bidder's questions as necessary (514), until the item is successfully auctioned.

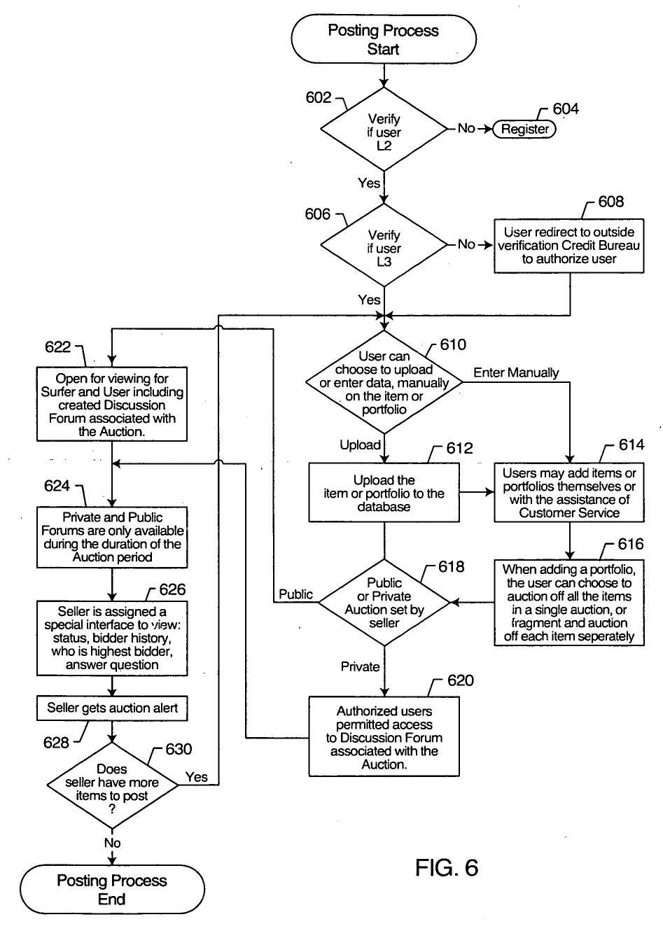

With reference now to FIG. 6, a flow chart illustrating more detailed steps taken in the posting process is shown. As described above, the user must be first verified as having a level 2 access (602) and if not, the user must register to obtain this second level access (604). Then the user must be verified as having third level access (606). If the user is not, the user must register, such as by filling out “form 2”, and be directed to an outside verification credit bureau to authorize the user (608), as described above, or the seller may be directed to a phone verification as described above.

Once the user is verified as having a third-level registration and permitted access to post items, in the form of intangible and non-performing assets, the user/seller can either choose to upload the data concerning the one or more items for auction or have the information manually entered (610). When uploaded, the information is contained within a file of a recognized type, such as a spreadsheet file from Excel® or the like (612) which is compatible with the on-line forums database and capable of being extracted automatically. Otherwise, the user/seller may add items themselves manually by inputting the information by keyboard or the like into the appropriate spaces provided on the on-line forum, or with the assistance of customer service (614). The personnel may be representatives of the on-line forum or third-party representatives affiliated with the on-line forum and system administrator. In this case, the seller typically communicates the information via telephone or the like to a representative who, typically for a fee will manually enter the information obtained from the seller. Thus, the invention has the ability to “post by phone” and can assist those sellers who are unprofessional, unsophisticated or otherwise unfamiliar with computers.

As discussed above, the information may be automatically imported into the graphical representations, typically shown to the bidders as thumbnails unless selected and enlarged. Alternatively, the seller is given the option of having the information imported into a graphical representation, such as for a fee.

When a seller is posting a portfolio or has multiple assets that he wishes to auction off, the user/seller can choose to auction off all the items in a single auction as a lot, or fragment the portfolio and auction off each item separately or in smaller groups of items (616). This is contrary to the methodology in use currently, wherein large portfolios, referred to as “lots” or item off the items one item or non-performing asset per lot as a single option and fragment the portfolio into individual items or groups of items (616).

The seller then decides whether to conduct a public or private auction (618). That is, the seller can authorize that only certain buyers or classifications of potential bidders and buyers be allowed to participate in the auction. For example, the seller can choose that all level 2 users be participants in the private auction, only those identifying themselves as collection agents, skip tracers, etc., or specifically only a single set of buyers identified by the seller. The seller can also send out invitations to bid to specific bidders or a class of bidders.

Alternatively, the seller may choose to have a partial view or partially private auction. For example, in a partially private auction, only the title and dollar amount can be seen by the public, but not any of the other information can be viewed unless the user has been given privileges to see them. Thus, the surfers and/or potential bidders can only see a limited amount of information concerning the asset or lot of assets and the current bid or requested bid amount. The users will be able to send a request to the seller to gain access and participate in the semi-private auction. The seller can then decide which potential buyers to invite or accept their request. The authorized users/bidders may be the only ones authorized to view the auction in a private auction, whereas in a semi-private auction a limited amount of information is viewable by all or a certain level access group. In either the private or semi-private auctions, only those permitted access to the auction are granted access to the discussion forum associated with the auction so as to discuss the auction and ask the seller questions (620).

If the auction is to be a public auction, the auction is open to viewing by surfers and users and the discussion forum associated with the auction is capable of being viewed by all (622). The private and public forums are typically only available during the duration of the auction period (624). This is in contrast to the “common forums” that are created by anyone for the sake of discussions by users on various topics to share information and ideas. The common forums do not close and are accessible to anyone, although surfers can only read, but not participate.

In either the public or private auctions, the seller may decide to remain anonymous so, for example, to not be associated with any of the information contained within the items for auction, for publicity purposes, or to give the impression that a lower bid would be acceptable. The identity of the seller can remain completely anonymous through the escrow process, or after the highest bidder has won the auction, the identity of the seller can be disclosed at that time to consummate the transaction.

The seller is typically assigned a special interface to view the status of the auction, the bidder history, the current highest bidder, and answer any questions in the public or private forums established for communication between the bidders and the seller (626). The seller may also obtain auction alerts (628) informing of changes during the auction process, such as when a bidder is attempting to communicate with a seller or a new highest bid has been created.

In order to generate money for the on-line forum, the seller may be required to pay a fee to auction each item or group of items, pay additional fees to enhance the interface and obtain auction alerts, etc. Revenue may also be generated from the buyer, or it may be a percentage of the sale. Alternatively, these services may be offered for free and the on-line forum rely exclusively on third-party advertisement and payments for linkages and the like.

If the seller has more items to post (630) then the process begins anew, or the posting process ends. The present invention contemplates allowing debt sellers to maintain storefronts and pay a fixed fee or percentage of business generated from their storefront that is promoted or affiliated with the auction site of the present invention.

Those skilled in the art will appreciate that the present invention provides an on-line system for maximizing the number of potential buyers to sellers for intangible assets, such as non-performing assets and the like. The invention enables a seller to be as large as a large organization to as small as a small business or even an individual or a government entity. Even medium sized and large business will find benefits using the system of the present invention as their portfolio can be broken up into individual items or much smaller groups of items instead of a large lot or portfolio of assets which must be sold as a single unit, as is presently the case. The present invention also caters to those non-professionals by including buyer/seller resource links in the form of educational information and in the form of step-by-step procedures designed for the “first timers” as well as links to third-parties who may be able to offer professional assistance and guidance. Using the present invention, the seller has great control over how to present the information contained within the non-performing assets, whether to hold private, semi-private or public auctions and the ability to choose the participants in the private or “partial view” options. The seller's identify is also able to be maintained in annonynmity. However, the seller need not be a professional or experienced person or entity as the educational and resource links can assist the seller as well as the buyer. Furthermore, the on-line forum provides manual posting by phone or the like, facilitates communication between the seller and potential buyers, and can alert the seller as to the progress of the auction and buyers trying to communicate with the seller or consummate a transaction through a third party escrow. Thus, the present invention provides intangible assets in the form of non-performing assets or bad debt to not only large institutions and professionals, but small businesses, individuals and non-professionals. The present invention enables people to work from home by providing an on-line marketplace for the non-professional for these services.

Although several embodiments have been described in detail for purposes of illustration, various modifications may be made without departing from the scope and spirit of the invention. Accordingly, the invention is not to be limited, except as by the appended claims.

What is claimed is:

1. A method for conducting an online forum for auctioning non-performing intangible assets on a communications network, comprising the steps of:
permitting access to a limited amount of information including viewing auctions and online discussions, in the online forum without registration;
accessing additional information including participation in online discussions, in the online forum following completion of a first level registration; and
bidding on assets offered in the online forum following completion of a second level registration.

2. The method of claim 1, including the step of offering for auction sale unlisted/unregistered assets in the online forum following completion of a third level registration.

3. The method of claim 2, wherein the offering step includes the step of obtaining third party credit verification of a seller.

4. The method of claim 1, including the step of facilitating collection assistance to online forum bidders.

5. The method of claim 4, wherein the assistance providing step includes the step of facilitating educational tutorials in the online forum.

6. The method of claim 4, wherein the assistance facilitating step includes the step of providing links to third party sources of collection information in the online forum.

7. The method of claim 6, wherein the third party links include links to collection professionals.

8. The method of claim 6, wherein the third party links include links to public records potentially containing debtor location or asset information.

9. The method of claim 1, including the step of facilitating direct communication between a registered potential bidder and a registered seller of assets being auctioned in the online forum.

10. The method of claim 9, wherein the communication facilitating step comprises providing an online discussion forum for users having a first level registration.

11. The method of claim 9, including the step of facilitating private communication between a seller and a selected buyer or group of buyers.

12. The method of claim 2, including the step of a seller conveying-information concerning the assets to be auctioned to the online forum.

13. The method of claim 12, wherein the conveying step comprises using the communications network to convey a file containing asset information.

14. The method of claim 12, wherein the conveying step comprises contacting representatives of the online forum by telephone for manual input of asset information by the representatives.

15. The method of claim 12, wherein the assets comprise a single asset or a plurality of assets offered as a lot.

16. The method of claim 15, wherein the assets comprise a non-performing intangible asset.

17. The method of claim 2, including the step of permitting a seller to choose an auction open to all bidders, or restricted to a selected group of one or more bidders.

18. The method of claim 17, wherein the restricted auction comprises a partial view auction wherein the auction is restricted to a selected group of one or more bidders, but at least a limited amount of information concerning the auction is displayed for all forum users to view.

19. The method of claim 18, including the step of permitting non-selected bidders to request to participate in the auction.

20. The method of claim 17, including the step of the seller inviting the selected one or more bidders to participate in the auction.

21. The method of claim 1, including the step of subscribing to an auction alert, wherein a bidder is informed by the online forum when a higher bid than the bidder's has been made for an asset.

22. The method of claim 21, wherein the informing step comprises using e-mail, instant messaging, or telephonic communication.

23. The method of claim 1, including the step of creating a graphical representation of each asset for viewing at the online auction forum.

24. The method of claim 23, wherein the graphical representation includes at least one of a dishonored check, a court document, or an invoice.

25. The method of claim 1, including the step of rating a seller or buyer after an auction.

26. A method for conducting an online forum for auctioning non-performing assets on a communications network, comprising the steps of:
a seller offering for auction sale a single asset or a plurality of assets as a lot in the online forum following completion of a third level registration by the seller;
conveying information concerning the assets to be auctioned, from the seller to the online forum;
facilitating direct communication between one or more registered potential bidders and the seller by providing an online discussion forum;
permitting access to a limited amount of information, including viewing auctions and the online discussion forum between sellers and buyers, without registration;
accessing additional information, including participation in the online discussion forum, following completion of a first level registration; and
bidding on assets offered in the online forum following completion of a second level registration.

27. The method of claim 26, wherein the offering step includes the step of obtaining third party credit verification of the seller.

28. The method of claim 26, including the step of facilitating collection assistance to online forum bidders.

29. The method of claim 28, wherein the assistance facilitating step includes the step of facilitating educational tutorials in the online forum.

30. The method of claim 29, wherein the assistance facilitating step includes the step of providing links to third party sources of collection information in the online forum, including links to collection professionals or links to public records potentially containing debtor location or asset information.

31. The method of claim 26, including the step of facilitating direct private communication between a seller and a selected buyer or group of buyers.

32. The method of claim 26, wherein the conveying step comprises the step of using the communications network to convey a file containing asset information.

33. The method of claim 26, wherein the conveying step comprises the step of contacting representatives of the online forum by telephone for manual input of asset information by the representatives.

34. The method of claim 26, wherein the assets comprise a non-performing intangible asset.

35. The method of claim 26, including the step of permitting the seller to choose an auction open to all bidders, or restricted to a selected group of one or more bidders.

37. The method of claim 35, wherein the restricted auction comprises a partial view auction wherein the auction is restricted to a selected group of one or more bidders, but at least a limited amount of information concerning the auction is displayed for all forum users to view.

38. The method of claim 37, including the step of permitting non-selected bidders to request to participate in the auction.

39. The method of claim 35, including the step of the seller inviting the selected one or more bidders to participate in the auction.

40. The method of claim 26, including the step of subscribing to an auction alert, wherein a bidder is informed by the online forum by e-mail, instant messaging, or telephonic communication when a higher bid than the bidder's has been made for an asset.

41. The method of claim 26, including the step of creating a graphical representation of each asset for viewing at the online auction forum.

42. The method of claim 41, wherein the graphical representation includes at least one of a dishonored check, a court document, or an invoice.

43. The method of claim 26, including the step of rating the seller or buyer after an auction.

44. A method for conducting an online forum for auctioning non-performing intangible assets on a communications network, comprising the steps of:
offering for auction sale non-performing assets in a lot as a single asset or a plurality of assets in the online forum following completion of a third level registration by a seller;
conveying information concerning the assets to be auctioned from the seller by using the communications network to convey a file containing asset information, or contacting representatives of the online forum by telephone for manual input of the asset information;
facilitating direct communication between one or more registered potential bidders and the seller by providing an online discussion forum;
permitting access to a limited amount of information, including viewing auctions and the online discussion forum between sellers and buyers, without registration;
accessing additional information, including participation in the online discussion forum, following completion of a first level registration;
bidding on assets offered in the online forum following completion of a second level registration; and
facilitating collection assistance to online forum bidders.

45. The method of claim 44, wherein the offering step includes the step of obtaining third party credit verification of the seller.

46. The method of claim 44, wherein the assistance facilitating step includes the step of facilitating educational tutorials in the online forum or providing links to third party sources of collection information in the online forum, including links to collection professionals or links to public records potentially containing debtor location or asset information.

47. The method of claim 44, including the step of facilitating direct private communication between the seller and a selected buyer or group of buyers.

48. The method of claim 44, including the step of permitting the seller to choose an auction open to all bidders, or restricted to a selected group of one or more bidders.

49. The method of claim 48, wherein the restricted auction comprises a partial view auction wherein the auction is restricted to a selected group of one or more bidders, but at least a limited amount of information concerning the auction is displayed for all forum users to view.

50. The method of claim 49, including the step of permitting non-selected bidders to request to participate in the auction.

51. The method of claim 48, including the step of the seller inviting the selected one or more bidders to participate in the auction.

52. The method of claim 44, including the step of subscribing to an auction alert, wherein a bidder is informed by the online forum by e-mail, instant messaging, or telephonic communication when a higher bid than the bidder's has been made for an asset.

53. The method of claim 44, including the step of creating a graphical representation of an asset for viewing at the online auction forum, including at least one of a dishonored check, a court document, or an invoice.

54. The method of claim 44, including the step of rating a seller or buyer after an auction.
